(19) United States
(12) Patent Application Publication
(10) Pub. No.: US 2006/0051652 A1
(43) Pub. Date: Mar. 9, 2006

(54) Interleave machine and method for stacking flat objects

(76) Inventor: Edward Samuels, Pittsboro, NC (US)

Correspondence Address: CALFEE HALTER & GRISWOLD, LLP, 800 SUPERIOR AVENUE, SUITE 1400, CLEVELAND, OH, 44114, US

(21) Appl. No.: 11/190,757

(22) Filed: Jul. 27, 2005

Related U.S. Application Data
(60) Provisional application No. 60/591,910, filed on Jul. 28, 2004.

(51) Int. Cl. H01M 2/08

(52) U.S. Cl. 429/35

(57) ABSTRACT

An interleave machine for stacking a plurality of generally flat objects and a method for stacking a plurality of generally flat objects and components, steps and/or assemblies of an interleave machine, including but not limited to a Bernoulli pick up and place device and the steps of using the size and shape of a plate to determine the fold (or crease) point of a surrounding separator.

### CROSS-REFERENCE TO RELATED APPLICATIONS

This application claims priority to, and any other benefit of, U.S. Provisional Application Ser. No. 60/591,910, filed on Jul. 28, 2004, and entitled “INTERLEAVE MACHINE AND METHOD FOR STACKING FLAT OBJECTS,” which is hereby incorporated by reference in its entirety.

### BACKGROUND

Various manufacturing assemblies require more or less exact stacking of flat objects. Often objects of different sizes but similar geometry are alternately stacked. For example, capacitor plates can be stacked alternately with dielectric plates to form a precision capacitor. In another example, a positive battery plate, a separator material and a negative battery plate can be stacked alternately to form an electrical cell or battery.

Such stacking, however, can be labor intensive and costly. This is particularly true when one or more of the flat objects are thin, fragile or otherwise sensitive to manual touch. In the above example of a battery, alternate stacking of positive and negative plates (each with a thickness, e.g., on the order of 0.007 of an inch) interlaced with a polymeric separator (with a thickness, e.g., on the order of 0.0008 of an inch) requires multiple hours of hand labor, at increasingly high manufacturing costs.

### SUMMARY

The present invention relates to an interleave machine for stacking a plurality of generally flat objects, a method for stacking a plurality of generally flat objects and components, steps and/or assemblies of an interleave machine, including but not limited to a Bernoulli pick up and place device and the steps of using the size and shape of a plate to determine the fold (or crease) point of a surrounding separator.

Numerous other advantages and features of the present invention will become readily apparent from the following detailed description of the invention and the embodiments thereof, from the claims and from the accompanying drawings.

### BRIEF DESCRIPTION OF THE DRAWINGS

The invention as well as embodiments and advantages thereof are described below in greater detail, by way of example, with reference to the drawings in which:

FIG. 1 is a schematic diagram of an interleave machine in accordance with an embodiment of the present invention;

FIG. 2 is a perspective view of a feed hopper of the interleave machine of FIG. 1;

FIG. 3 is a perspective view of a plate of the interleave machine of FIG. 1;

FIG. 4 is a side view of a separator guide of the interleave machine of FIG. 1;

FIG. 5 is a side view of an, edge guide of the interleave machine of FIG. 1;

FIG. 6 is a cross-sectional view of a fold fixture of the interleave machine of FIG. 1;

FIG. 7 is a perspective view of the clamp of the fold fixture of FIG. 6;

FIG. 8 is a perspective view of a clamp assembly of the interleave machine of FIG. 1;

FIG. 9 is a perspective view of a cassette of the interleave machine of FIG. 1;

FIG. 10 is a schematic view of a plate transfer device of the interleave machine of FIG. 1;

FIG. 11 is a schematic diagram of an interleave machine;

FIG. 12 is a side view of two plate transfer devices in an interlocked position;

FIG. 13 is a perspective view of a separator guide bar of the interleave machine of FIG. 1;

FIG. 14 is a side schematic view of a separator guide assembly of the interleave machine of FIG. 1;

FIG. 15 is a side schematic view of the brake of the separator guide assembly of FIG. 14;

FIGS. 16(A)-16(E) is a flow chart of an exemplary methodology for stacking a plurality of plates;

FIG. 17 is an exemplary perspective view of a battery having stacked plates; and

FIG. 18 is a flow chart of an exemplary methodology for stacking a plurality of plates.

### DETAILED DESCRIPTION

While this invention is susceptible of embodiment in many different forms, there are shown in the drawings and will be described herein in detail specific embodiments thereof with the understanding that the present disclosure is to be considered as an exemplification of the principles of the invention and is not intended to limit the invention to the specific embodiments illustrated.

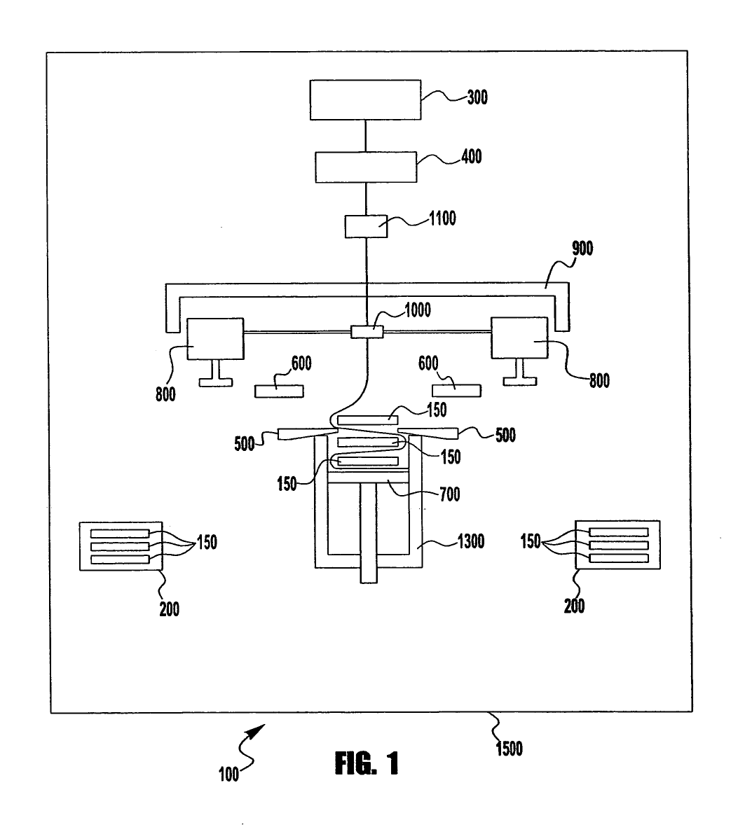

With reference to FIG. 1, an overview of an exemplary interleave machine 100 is shown. Interleave machine 100 optionally includes one or more of the following: a feed hopper 200, a separator feeder 300, a separator tension 400 (not shown), a constant elevation fold fixture 500, an edge clamp 600 (not shown), a vertical elevator 700, a pickup and place device 800, a horizontal positioner 900, a separator guide bar 1000, a separator pinch tube 1100 and a build cassette 1300. Interleave machine 100 further optionally includes other components, including but not limited to controllers 1400 and 1450 and housing 1500.

Exemplary interleave machine 100 alternately stacks a plurality of generally flat objects 150. The objects are optionally of different sizes (or dimensions), of different compositions (i.e., materials) and require specific positioning with reference to each other. For example, an exemplary interleave machine 100 assembles a stack of Li-Ion battery plates. In this example, each plate is typically thin and fragile, having a thickness of about 0.007 of an inch. The stack alternates positive and negative plates, with the negative plate being both longer and wider than the positive plate. Each plate is separated from the other by a layer of a polymeric separator (a “separator”) having a thickness of about 0.0008 of an inch. The separator is fan or accordion folded so as to be continuous from the top to the bottom of the stack. Each positive plate is positioned in the center of each abutting negative plate, while separated by a separator layer.

While the above example is illustrated with respect to alternating plates and a separator each having a certain order of thickness, it will be appreciated that any suitable battery components are optionally stacked with exemplary interleave machine 100. For example with a battery stack, any suitable number of positive and negative plates, each with any suitable dimensions and positioning, are stacked. Similarly, any suitable separator is interwoven between each plate. Such exemplary battery stacks are discussed further below.

It will further be appreciated that any suitable stackable components are optionally stacked with exemplary interleave machine 100. Exemplary suitable stacking components are of any suitable thickness, including but not limited to components of a thickness between about 0.02 of an inch and 0.005 of an inch, although any thickness may be used. Generally speaking, the lower level of thickness of a component (i.e., how thin it is) is determined by the ability of the material of the component to withstand the pressure of the crease (or fold) of the separator (as described below) without bending, buckling or otherwise being compromised. So long as the component (e.g., a plate) is capable of withstanding such pressure, such a component is optionally of any thickness. Similarly, a component is also optionally of any thickness (including greater than 0.005 of an inch), so long as it is capable of withstanding such pressure without such compromise. In an exemplary embodiment, an interleave machine 100 stacks four different plates into a single stack, each plate separated by a suitable separator. While any suitably stackable components are optionally stacked with exemplary interleave machine 100, exemplary interleave machine 100 is described herein with respect to the battery stack example set forth above. It will be appreciated that the descriptions herein are not intended to be limited to such an exemplary embodiment, and are optionally applied to any suitable stacking components.

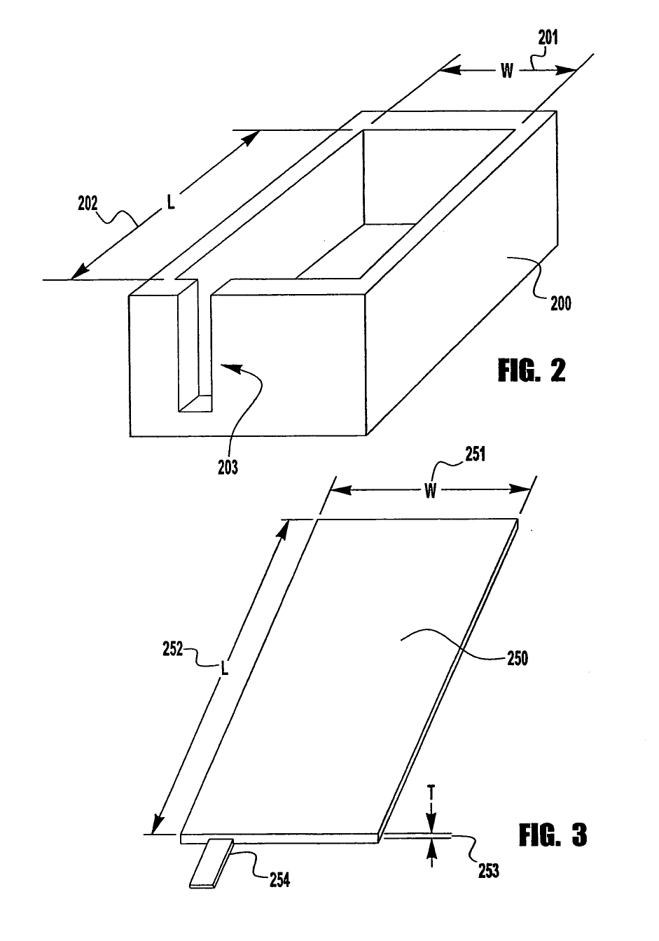

The interleave machine 100 optionally includes one or more feed hoppers 200. Each feed hopper 200 is adapted to receive one or more plates. With reference to FIG. 2, an exemplary feed hopper 200 is illustrated. Exemplary feed hopper 200 is adapted to receive one or more plates of the size and shape as illustrated by exemplary plate 250 in FIG. 3. Exemplary plate 250 has a width 251, a length 252 and a thickness 253, and further has a terminal 254 protruding from one end thereof. While exemplary plate 250 is illustrated with particular dimensions and shape (including, e.g., terminal 254), it will be appreciated that any suitable dimensions and shape is optionally used.

Exemplary feed hopper 200 has a width 201, a length 202 and an aperture adapted to receive one or more of exemplary plates 250. Feed hopper's 200 width, length and aperture are sized slightly larger than the width, length and terminal of exemplary plate 250, facilitating stacking of the plate(s) 250 and lifting of the plate(s) 250 out of the hopper 200. Any suitable amount of clearance may be used. A suitable clearance is 0.003 of an inch for each dimension.

Feed hopper 200 has any suitable depth to contain any suitable number of plates. For example, feed hopper 200 has a height which is adapted to receive about 200 plates 250 stacked on top of each other. Each plate is positioned within hopper 200 so that the terminal protrudes through aperture 203. Feed hopper 200 is adapted to contain a plurality of plates 250 in at least roughly the same orientation.

Feed hopper 200 optionally has adjustable sides and variable depth to facilitate adaption to multiple and varying dimensions, shapes and protrusions of varying plates. For example, feed hopper 200 may be defined by a plurality of electrode feed stops, each of which is movable to adapt to differing dimensions of a plate.

Feed hopper 200 further optionally has adjustably variable depth. For example, the height of the topmost plate in the stack contained within the hopper may be determined by number of plates in the stack; i.e., the more plates in the stack, the higher the topmost plate, while the last plate in the stack will rest against the bottom of the hopper. Feed hopper 200 optionally includes a variable height adjustor (not shown), capable of adjusting the height of the topmost (and all other) plates contained within the hopper. In this regard a constant feed height for the topmost available plate may be provided. The height is adjusted by any suitable mechanism, including but not limited to an elevator contained at the bottom of the feed hopper. An exemplary such elevator is spring biased based upon the weight of the plates, so that removing the topmost of the stack of plates causes the stack to move up so that the next topmost plate is maintained at a constant vertical position.

Furthermore, each hopper 200 is mounted on a base 270 of interleave machine 100 so that the position of each hopper is fixed. Each hopper mounting is optionally adjustable so that the fixed position of each hopper is movable depending upon the configuration of the plates, desired stack, etc. In the battery example referenced above, the exemplary interleave machine 100 has two feed hoppers 200, one hopper for positive plates and one hopper for negative plates. Each hopper is placed on the opposite side of the stack, as illustrated in FIG. 1 and discussed below.

The interleave machine 100 optionally includes a separator feeder 300 and a separator tension 400. Separator feeder 300 provides any separator used by the interleave machine 100 to create a stack. Separator tension 400 provides at least part of the tension placed upon the separator.

A separator is any suitable material for separating plates of a stack, as described more fully below. The separator is generally provided in a continuous sheet, and is capable of fan or accordion folding around one or more plates. The separator is provided by any suitable source. A suitable source for a separator is a roll of a separator.

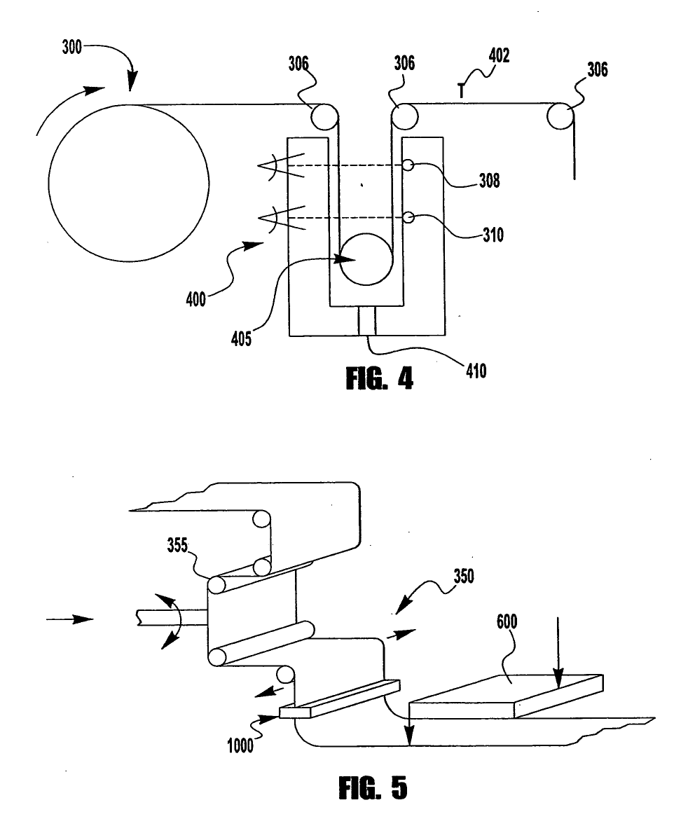

With reference to FIG. 4, an exemplary separator feeder 300 and an exemplary separator tension 400 is illustrated. Exemplary separator feeder 300 includes a roll of separator 302 and optionally a motor drive 304 (not illustrated), a plurality of rollers 306 and a plurality of sensors 308 and 310. In this example, the separator is rolled on the exterior of roll 302 and is accessed by rotating roll 302. Roll 302 is optionally driven by motor drive 304 to facilitate unrolling of separator. A plurality of rollers 306 is optionally used to direct the separator, including, as described below, past tension 400.

First sensor 308 optionally causes the motor 304 to unwind the separator material until sensor 310 is triggered (by, e.g., passing it), which stops the motor and the unwinding of the separator. Unwinding is stated and stopped as needed to create a stack. While an exemplary separator feeder 300 is illustrated in FIG. 4, it will be appreciated that any suitable mechanism for supplying separator material is optionally used.

The separator feeder 300 optionally passes the separator by separator tension 400. Separator tension 400 places a tension T 402 on separator, and is optionally variable depending upon the tension desired for creating a stack. Separator tension 400 is any suitable mechanism for providing tension on the separator, including but not limited to spring loading, smart rollers and an active dancer. In the exemplary embodiment illustrated in FIG. 4, separator tension 400 includes one or both of dancer 405 and vacuum 410. The weight of dancer 405 and the force of vacuum 410 either or both optionally provide tension 402 to the separator. Tension 402 can be varied by differing size and/or weight of dance 405 and differing magnitudes of vacuum 410. Tension 402 is any suitable amount of tension, and is optionally preset to a predetermined value. Tension 402 is optionally relative depending upon the characteristics of the plates in the build stacks. For example, Tension 402 is optionally determined by testing the amount of tension build stack plates can withstand without bending, warping or otherwise being compromised. Tension 402 is set slightly below this force amount. Tension 402 is optionally set in advance of stack building by testing a plate with a separator. Tension 402 may vary depending upon ambient conditions (temperature, humidity, etc.) and is optionally modified as such conditions change.

With reference to FIG. 5, the separator feeder 300 optionally includes or at least is connected to an edge guide 350. Edge guide 350 is any suitable mechanism for moving the edge of the separator in or out relative to the stack. A suitable mechanism is illustrated in FIG. 5. Exemplary edge guide 350 includes a plurality of piloted rollers 355 which are capable of being tilted skew to the horizontal, causing the separator to ride up or down, thereby moving the edge of the separator in or out relative to the stack. Edge guide 350 is optionally located after the separator tension 400 and prior to the separator guide bar (discussed below).

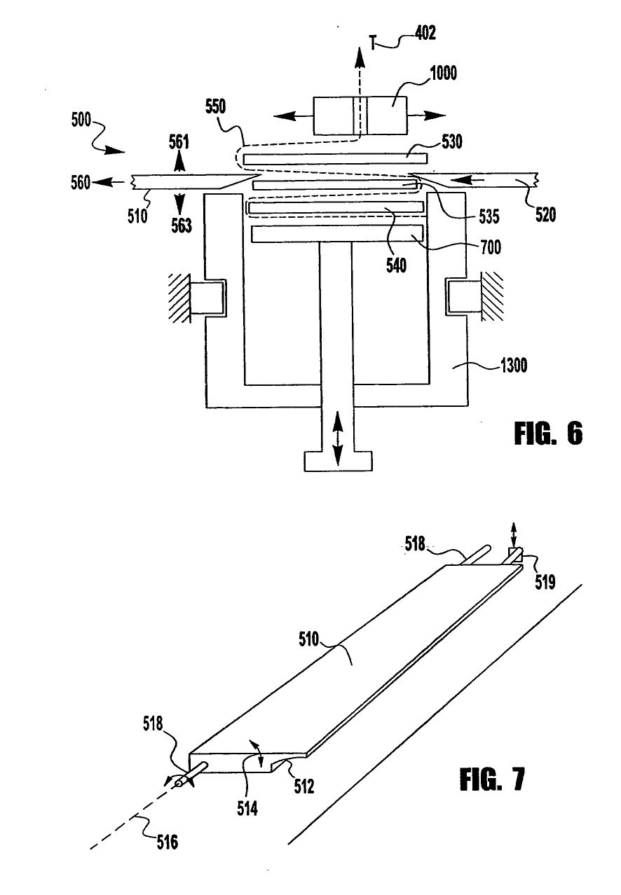

With reference again to FIG. 3, interleave machine 100 optionally includes a constant elevation fold fixture 500. Constant elevation fold fixture 500 facilitates uniform folds of the separator around edges of the plates of the stacks. Fold fixture 500 includes at least two rigid metal forms, one for each side for folding. Any suitable rigid metal form for facilitating uniform folds is used. An exemplary fold fixture 500 is an anvil, as illustrated in FIGS. 6-8.

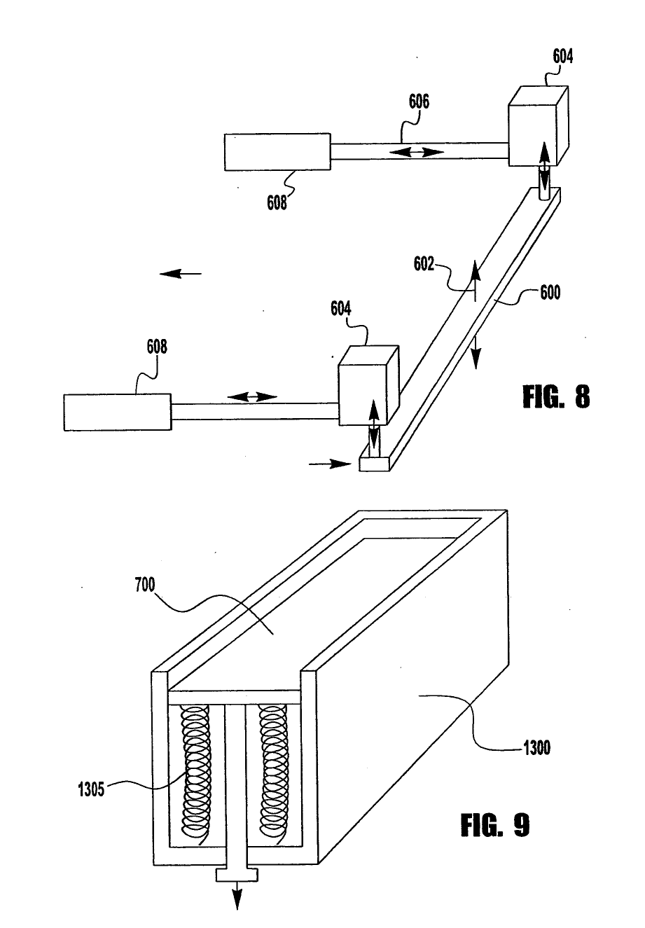

With reference to FIG. 6 fold fixture 500 includes a left anvil member 510 and a right anvil member 520. Left anvil member 510 is further illustrated in FIG. 7. With reference to FIG. 7, anvil member 510 has a lip 512 for facilitating a fold or crease of separator around the edge of a plate. Anvil member 510 rotates 514 around an axis 516 defined by a pair of pegs 518 which protrude from the edge of anvil member 510. Rotation 514 is facilitated or blocked by actuator 519. While anvil member 510 has been illustrated as having exemplary features for facilitating rotation 514, it will be appreciated that any suitable mechanism is optionally used to facilitate rotation 514 of anvil member 510. Furthermore, while only anvil member 510 is illustrated in FIG. 7, it will be appreciated that anvil member 520 has similar features to anvil member 510.

With reference to FIG. 6, anvil members 510 and 520 are shown in relation to build cassette, vertical elevator and separator guide bar (both discussed below). With reference to FIG. 6, the anvil members are shown with relation to a plurality of plates 530, 535 and 540 and separator 550. Each plate is used as a form around which the separator 550 is folded. For example, separator 550 is folded around the left hand (with respect to FIG. 6) edge of plate 540, around the right hand edge of plate 535 and the left hand edge of plate 530. Each fold or crease is accomplished at a constant elevation as defined by anvil members 510 and 520. In this example, after tension 402 pulls the separator taught, a clamp forms a fold against the top of the anvil (here, anvil member 510 with respect to plate 530). The anvil member 510 translates out 560, up 561, in 562 (with respect to anvil member 520) and down 563 to place the fold on the under side of the anvil (anvil member 510) and make the top side of the anvil (anvil member 520) available for the next fold. This completed process is illustrated with respect to plate 535, wherein the fold is on the underside of anvil member 520 and the top side of anvil member 510 is available for the next fold (as described above). As discussed below, the vertical elevator moves each plate in the stack downwards, so the that top of the stack is at the level of the anvil for folding of the separator around the plate at the top of the stack. The anvil member 510 is extended while anvil member 520 has translated out.

With reference to FIG. 8, interleave machine 100 further optionally includes one or more edge clamps 600. Each edge clamp 600 alternately secures the plate in the topmost position of the stack in position and provides a crease on alternate folds of the separator. The sequencing is such that the plate in the topmost position of the stack is always constrained by a squeeze between a clamp and an anvil. Any suitable mechanism for clamping a plate and/or the separator to an anvil is optionally used, including but not limited to an electromagnetic clamp or a fixed clamp. A suitable clamp is a round clamp with a flat side to clamp by moving the clamp up, rotating it to a radiused position, and moving the clamp down to hold the topmost plate in position. Another suitable clamp is illustrated in FIG. 8.

With reference to FIG. 8, exemplary edge clamp 600 is adapted to the length of the plates. The clamp 600 is vertically mobile 602 based upon one or more vertical actuator(s) 604 and horizontally mobile 606 based upon one or more horizontal actuator(s) 608. Exemplary clamp 600 is thus movable horizontally to facilitate clamping on one or more edges of a plate, and vertically movable to facilitate clamping and releasing the plate (against the anvil). For the exemplary battery stack, two edge clamps are provided, one for the left edges of the plates of the stack and one for the right edges.

With reference again to FIGS. 2 and 3, interleave machine 100 further optionally includes a vertical elevator 700 and a build cassette 1300. Build cassette 1300 is a housing which contains the stacked plates and separator. Vertical elevator 700 is an elevator located within build cassette 1300 which facilitates vertical motion of the stack as additional plates are added to the stack. The elevator lowers the stack each time a plate is added or a separator is wrapped, so that the topmost stack and separator folds there around are at a constant vertical height as defined by the anvil.

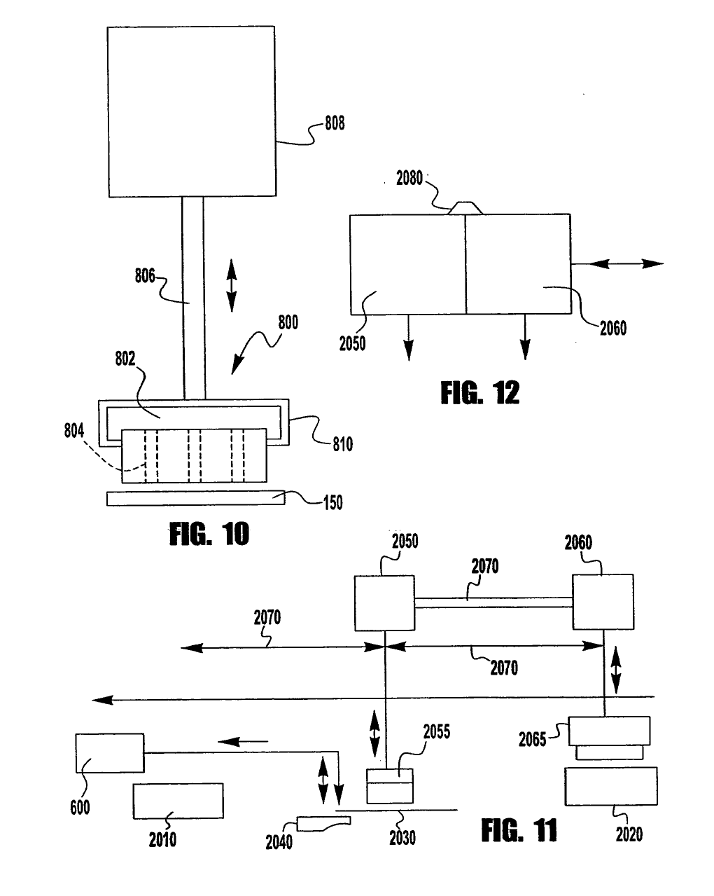

Build cassette 1300 is any housing suitable for containing a stack. An exemplary build cassette is illustrated in FIG. 9. With reference to FIG. 9, build cassette 1300 is adapted to enclose a stack comprising at least one plate. Build cassette 1300 is optionally roughly the shape and size of the largest of the plates which comprise the stack, increased in size to accommodate the separator which is folded around the largest plate. In the battery example, the build cassette 1300 is roughly rectangular and is adapted to include a vertical elevator 700 (described below) and optionally one or more guide rods and/or springs to actuate the elevator (also described below). Springs 1305 are optionally included to maintain a continuous force on the build stack after forming and during transport and storage. Build cassette 1300 is optionally removable from the interleave machine 100 to facilitate transport and storage of a stack

With reference to FIG. 1, build cassette 1300 is mounted under the anvils 600 to facilitate stack construction. Build cassette 1300 is mounted in any suitable way, including removably as described above.

Vertical elevator is any suitable vertical motion mechanism for lowering the stack beneath the anvils and into the build cassette 1300. For example, a vertical elevator is optionally computer-controlled (e.g., by a PLC) and is further optionally a generally commercially available computer-controlled lead screw. Another exemplary vertical elevator 700 is illustrated in FIG. 9. With reference to FIG. 9, vertical elevator 700 is spring loaded and is lowered upon completion of each plate/separator assembly. In the battery example, each plate/separator assembly is a combined 0.0078 of an inch thick. Upon completion of each such assembly, the vertical elevator 700 is lowered by 0.0078 of an inch to facilitate addition of a new plate/separator assembly at the vertical height of the anvils. The vertical elevator 700 is lowered by any suitable mechanism, including the weight of the stack. In the battery example, the vertical elevator is raised and lowered via a lead screw.

With reference again to FIG. 3, interleave machine 100 further optionally includes one or more pickup and place device(s) 800. Each pick up and place device is adapted to pick up a plate from a stack (optionally in a feed hopper 200) and place the plate on top of the stack (i.e., on top of the separator which is on top of the stack). Any device capable of picking up a plate and placing a plate, without damaging the plate, is optionally used. An exemplary device is a vacuum pick up and place device.

With reference to FIG. 10, an exemplary pick up and place device 800 is illustrated. Device 800 includes a vacuum 802 and a plurality of holes 804 in plane or platen 810 to facilitate vacuum pick up. Upon actuation of vacuum 802 (it will be appreciated that the actual vacuum device is in any suitable location, such as remote of the interleave machine, with a suction hose or similar device delivering the vacuum force 802), suction is delivered via holes 804 in the pick up plane 810. Actuator 808 raises and lowers 806 the pick up plane. When in a lowered position, the suction through the plane 810 picks a plate off of a stack (e.g., from a feed hopper 200) and retains the plate under the pick up plane. Actuator 808 raises 806 the plane to pick up the plate. The device 800 is moved to the stack location. Actuator 808 lowers 806 the plane to the top of the stack. Vacuum 802 is shut off, thus “dropping” the plate and placing it on the top of the stack.

With reference to FIG. 7, an additional embodiment of vacuum 800 is illustrated. Vacuum 800 includes a vacuum platen 830 for contacting a plate and a vacuum cylinder 820 for facilitating a vacuum force. In an additional embodiment, a “Bernoulli principal” based pick up and place device is used. In this embodiment, air is forced out of one or more holes in platen 810 towards the top plate in a feed hopper. Optionally, between four and six holes are used. As the proximity between the air holes (also, “jets”) and the plate decreases, the velocity of the “pushed” air escaped there between increases. As this velocity increases, the air pressure between the two decreases. As the air pressure decreases, the plate is levitated towards the jets and held in proximity thereto without actually contacting the pick up and place device.

Pick up and place device 800 is affixed to the interleave machine 100 in any suitable manner to facilitate picking up a plate, moving the plate to the stack, and placing the plate on the stack. With reference to FIG. 1, pick up and place device 800 is mounted on a horizontally movable carriage 900. The stack and the feed hopper are optionally horizontally aligned, so that the pick up and place device can pick up a plate, move horizontally only to the stack, and place the plate on the stack. Such an alignment further facilitates positioning and exact placement of the plate on the stack.

With reference again to FIGS. 2 and 4, interleave machine 100 further optionally includes a horizontal positioner 900. Horizontal positioner 900 facilitates horizontal movement of the one or more pick and place devices 800 within the interleave machine 100. Horizontal positioner 900 optionally moves the pick up and place devices 800 from and between the feed hopper(s) 200 and the stack. Any suitable mechanism for facilitating such horizontal movement is optionally used, including but not limited to manual, hydraulic and/or pneumatic actuators. A suitable mechanism is a carriage driven by a position encoded electrical bidirectional ram.

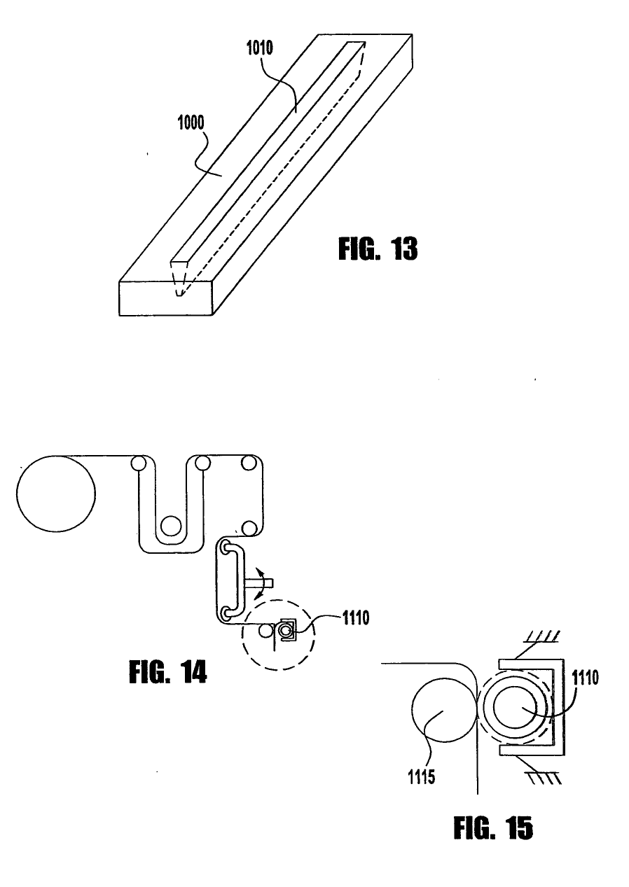

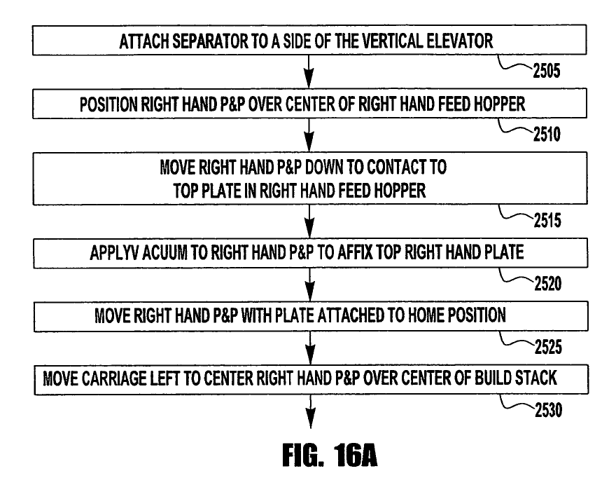

With reference to FIGS. 11 and 12, the function of an exemplary carriage 900 is illustrated. In this example (the battery example), interleave machine 100 has a left hopper 2010 and a right hopper 2020, with a build stack 2030 located on an anvil 2040 between the right and left hoppers. The interleave machine 100 also has a left pick up and place device 2050 with a vacuum 2055 and a right pick up and place device 2060 with a vacuum 2065. The pick up and place devices 2050 and 2060 are mounted on the carriage separated by a distance 2070 which is equal to the distance between the left hopper and the stack and the stack and the right hopper. The carriage with the pick up and place devices is horizontally movable between a leftmost and rightmost position, wherein the leftmost position the left pick up and place device is positioned over the left hopper and the right pick up and place device is positioned over the stack, and further wherein the rightmost position the left pick up and place device is positioned over the stack and the right pick up and place device is positioned over the right hopper. The mounting distance between the pick up and place devices on the carriage is optionally fixed, and fixed at a distance equal to the distance between the hoppers and the stack.

With such an alignment, when the pick up and place devices are lowered they either pick up a plate (if currently positioned over a hopper) or drop a plate on the stack (if currently positioned over the stack). With reference to FIG. 12, the pick up and place devices are optionally mounted adjacent to each other or otherwise so that they are not fixed at a distance equal to the distance between a hopper and the stack. In this embodiment, the horizontal positioner is horizontally movable over a greater distance to facilitate movement of each or both pick up and place devices over both hoppers and the stack, or either. A mechanical lock 2080 is optionally provided to hold the two pick up and place devices together.

With reference to FIG. 1, a carriage 900 is illustrated mounted in an interleave machine 100. Carriage 900 is optionally mounted on horizontal rails to facilitate horizontal movement. With reference to FIG. 1, carriage 900 horizontally moves on an x-axis slide.

Interleave machine 100 further optionally includes a separator guide bar 1000. Separator guide bar 1000 receives a separator of different widths and facilitates moving the separator right and left with respect to the stack. Guide bar 1000 is any suitable mechanism for receiving the separator and facilitating such movement, including but not limited to a mechanism including a plurality of guide rollers and a plurality of foam rollers to entrap the separator and gently manipulate it. An additionally suitable guide bar is illustrated in FIG. 13.

With reference to FIG. 13, guide bar 1000 has a separator slot 1010 adapted to received a separator and allow same to pass there through. The guide bar 1000 is optionally affixed rigidly to the carriage (or other horizontal positioner) to facilitate horizontal movement. With reference to FIG. 13, a guide bar 1000 is illustrated in proximity to the anvil and the vertical elevator. With reference to FIG. 5, a guide bar is positioned between the edge guide and the stack construct (here illustrated with a clamp and a plate).

Interleave machine 100 further optionally includes a separator pinch tube 1100, otherwise known as a separator brake. Brake 1100 breaks the tension 402 on separator by any suitable mechanism, including but not limited to an electromagnet, fixed magnets or similar means. A suitable mechanism is a pinch tube as illustrated in FIG. 14.

With reference to FIG. 14, brake 1100 optionally includes a pinch tube 1110. Pinch tube 1110 is any suitable expandable/contractible tube, such as, e.g., an air pressure tube comprised of rubber. Separator is fed in between pinch tube 1110 and a roller 1115. In contracted mode, pinch tube affords passing distance between pinch tube 1110 and roller 1115, allowing separator to pass between with tension 402. In expanded mode, pinch tube abuts roller 1115 and “pinches” separator therebetween, disallowing movement of the separator and effectively removing tension 402 beyond the pinch point (because the tension occurs “upstream” of the pinch point, as described below).

Brake 1100 is located “downstream” of the separator feeder 300 and separator tension 400, and “upstream” of the stack; i.e., brake is between the tension source and the stack. When not pinching, the brake allows the tension from the tension source to follow through to the stack. When pinching, tension is relieved from the pinch point through to the stack.

With further reference to FIGS. 1 and 2, interleave machine 100 further optionally includes one or more controllers 1400 and/or 1450. Controllers 1400/1500 provide manual and/or electronic control of all or some of the components of the interleave machine 100, and are optionally one or more PLC's. With reference to FIG. 1, interleave machine 100 further optionally includes housing 1500. Housing 1500 provides a controlled atmosphere for creating a stack. For example, housing 1500 is optionally a hood which maintains a relatively dust-free and moisture-free environment. Exemplary such housings are commercially available, for example, a “down-draft” hood.

In the battery exemplary embodiment, an interleave machine 100 is capable of creating a stack of 48 plates in about 12 minuets. In this example, interleave machine 100 is controlled by a PLC which allows a single p&p movement at a time. It will be appreciated, however, that any suitable PLC is used. For example, using a PLC which allows two activities to occur simultaneously (such as picking up a plate from a feed hopper simultaneously as the other p&p places a plate on the build stack) decreases this production time to, e.g., about 6 minutes.

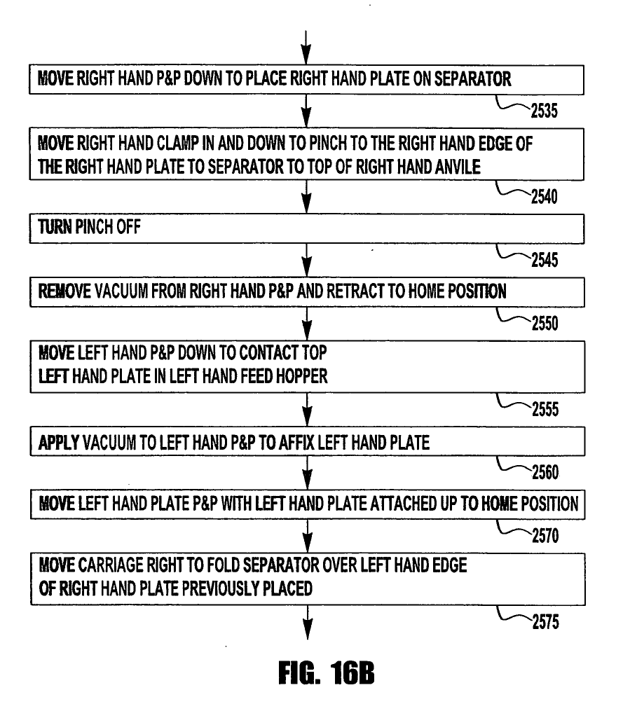

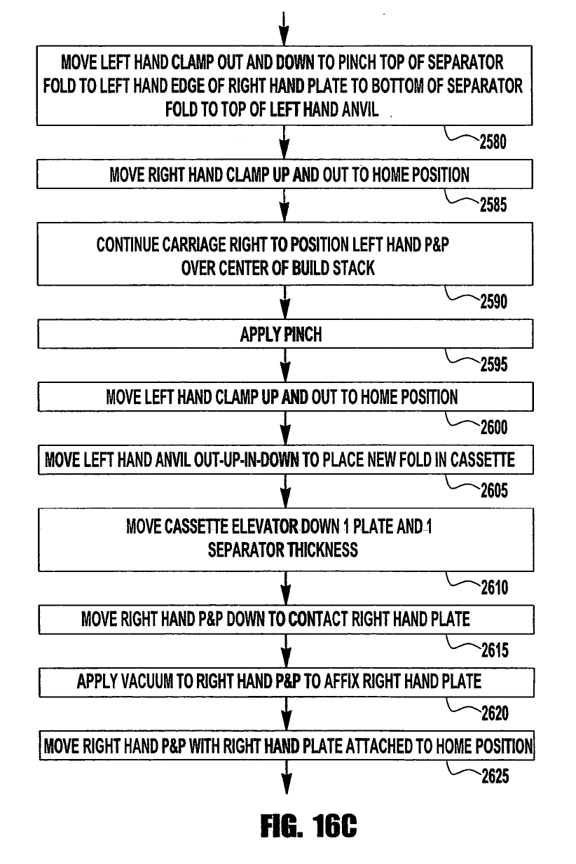

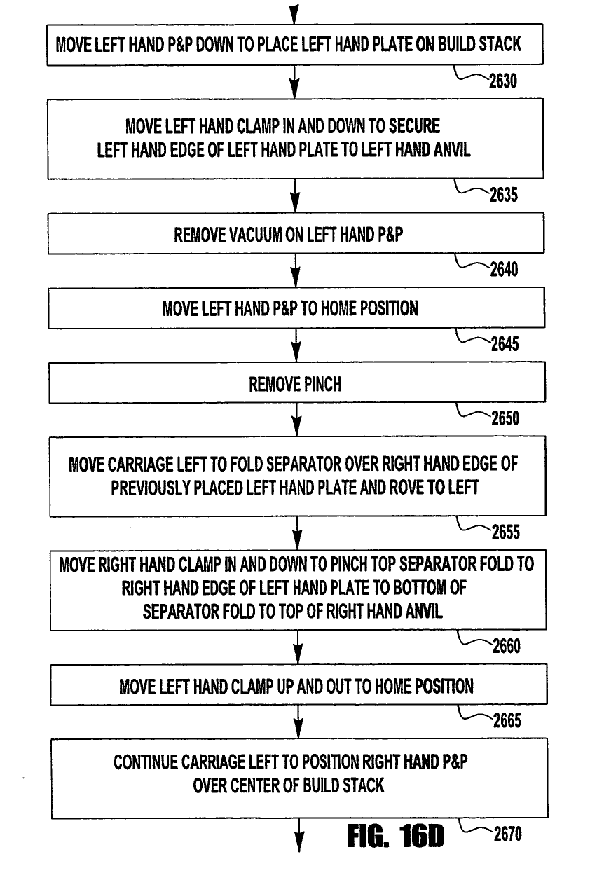

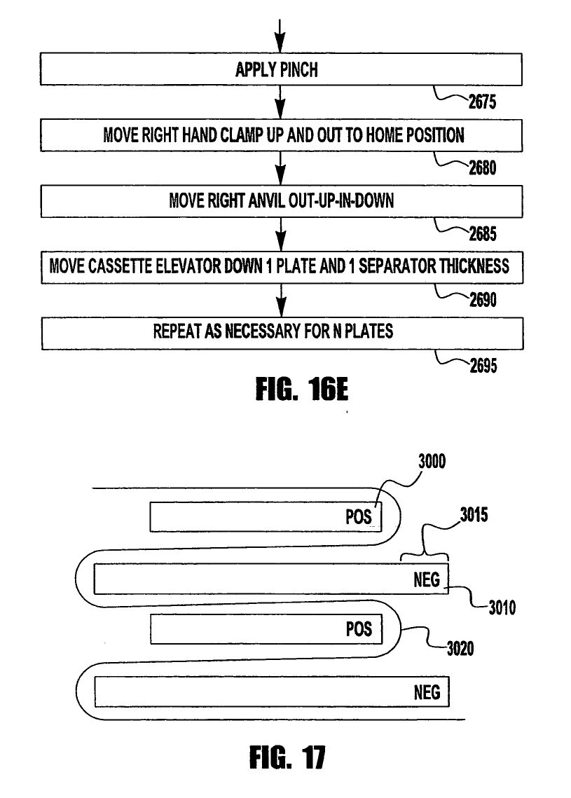

FIG. 16 shows an exemplary methodology for creating a stack of flat objects. The blocks shown represent functions, actions or events performed therein. It will be appreciated that such functions, actions or events can be performed in other sequences different than the one shown.

With reference to FIG. 16, an exemplary methodology is described. The exemplary methodology applies to the battery example set forth above, wherein an interleave machine has a left and a right feed hopper, each having at least one plate, a left and right pick up and place (p&p) device corresponding to each feed hopper, an anvil with a left and right member, a left and a right clamp, a carriage horizontally movable, a pinch device, and a vacuum device for a p&p device.

At block 2505, an end of the separator is attached to a side of the vertical elevator. In this example, it is attached to the right side. The separator will provide the bottom to the stack. At block 2510, position the right hand p&p over the center of the right hand feed hopper, and at block 2515 move the right hand p&p down to contact the top plate in the right hand feed hopper. At block 2520, apply a vacuum force to the right hand p&p to affix the top right hand plate to the p&p. At block 2525, move the right hand p&p with the plate attached to the home position (i.e., move it upwardly). At block 2530, move the carriage left to center the right hand p&p over the center of the build stack.

At block 2535, move the right hand p&p down to place the right hand plate on the separator on the vertical elevator. At block 2540, move the right hand clamp in and down to pinch to the right hand edge of the right hand plate to separator to top of the right hand anvil. At block 2545, turn the pinch off. At block 2550, remove the vacuum force from the right hand p&p and retract to the home position.

At block 2555, move the left hand p&p down to contact the top left hand plate in the left hand feed hopper. At block 2560, apply vacuum force to left hand p&p to affix the left hand plate to the p&p. At block 2570, move the left hand p&p with the left hand plate attached up to the home position. At block 2575, move the carriage right to fold the separator over the left hand edge of the right hand plate previously placed. At block 2580, move the left hand clamp out and down to pinch top of the separator fold to the left hand edge of the right hand plate to the bottom of the separator fold to top of the left hand anvil. At block 2585, move the right hand clamp up and out to the home position.

At block 2590, continue the carriage to the right to position the left hand p&p over the center of the build stack. At block 2595, apply pinch. At block 2600, move the left hand clamp up and out to the home position. At block 2605, move the left hand anvil out, up, in and down to place new fold in the cassette.

At block 2610, move the cassette elevator down one plate and one separator thickness. At block 2615, move the right hand p&p down to contact the right hand plate. At block 2620, apply a vacuum force to the right hand p&p to affix the right hand plate. At block 2625, move the right hand p&p with the right hand plate attached to the home position. At block 2630, move the left hand p&p down to place the left hand plate on the build stack. At block 2635, move the left hand clamp in and down to secure the left hand edge of the left hand plate to the left hand anvil. At block 2640, remove the vacuum on the left hand p&p. At block 2645, move the left hand p&p up to the home position, and at block 2650, remove pinch

At block 2655, move the carriage left to fold the separator over the right hand edge of the previously placed left hand plate and rove to the left. At block 2660, move the right hand clamp in and down to pinch the top separator fold to the right hand edge of the left hand plate to the bottom of the separator fold to the top of the right hand anvil. At block 2665, move the left hand clamp up and out to the home position.

At block 2670, continue the carriage to the left to position the right hand p&p over the center of the build stack. At block 2675, apply the pinch. At block 2680, move the right hand clamp up and out to the home position. At block 2685, move the right anvil out, up, in and down. At block 2690, move the cassette elevator down one plate and one separator thickness.

At block 2695, repeat the above process (blocks 2535-2690) for each plate.

FIG. 18 shows another exemplary methodology for creating a stack of flat objects. At block 3000 a plate is obtained from a feed hopper. In embodiments wherein multiple hoppers exist (e.g., a left and right hopper), a plate is obtained from one hopper (e.g., the right hand hopper). At block 3001 the plate is placed on the build stack. In embodiments wherein a p&p device is used with a carriage, the p&p device is horizontally moved with the carriage over to the build stack, and the plate is lowered to the build stack. At block 3002, the separator is folded over the plate. At block 3003, the cassette elevator is moved down the thickness of one plate and one separator. At block 3004 a determination is made as to whether additional plates will be added to the build stack. If such additional plates exist, processing continues back at block 3000. In embodiments wherein multiple feed hoppers are used, the “next” plate is obtained from a different hopper (e.g., in a method with two feed hoppers, the hoppers alternate as a supply of plates). If such plates do note exist, processing stops at block 3005 and the cell is complete. It will be appreciated that in different embodiments certain steps optionally take place simultaneously or roughly simultaneously, such as, e.g., in a system having dual p&p devices, a plate is optionally picked up by one p&p device while the other p&p device is depositing a plate on to the build stack.

Although the flow chart herein shows exemplary orders of execution, it is understood that the order of execution for other embodiments may differ from that which is depicted. Also, two or more blocks shown herein may be combined and/or executed concurrently or with partial concurrence. It is understood that all such variations are within the scope of various embodiments of the present invention.

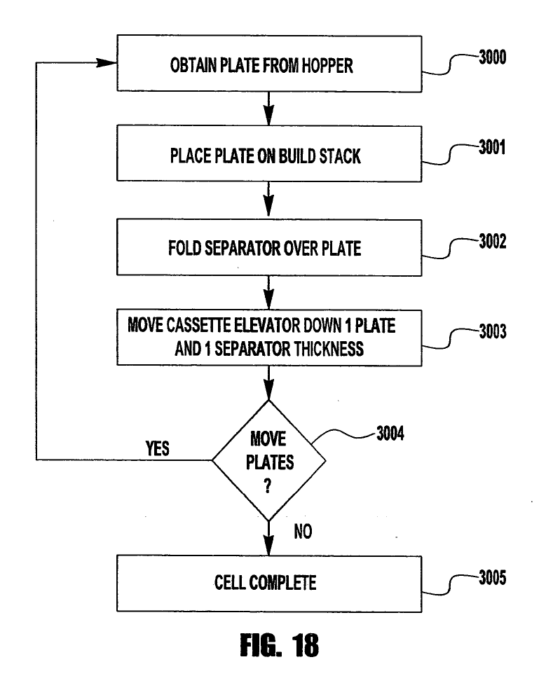

An exemplary battery produced by an interleave machine or a method as set forth above is illustrated in FIG. 17. The cell contains at least one positive plate(s) 3000, at least one negative plate(s) 3010 and a fan/accordion fold separator 3020.

Each positive plate is centered within the negative plate(s) abutting it (through the separator). The battery (or the cell) has positive plates completely covered by a layer of separator material and negative plates covered but for a small amount 3015 exposed on one side (corresponding to the terminal). In an embodiment, the 3015 exposure is approximately 0.04 of an inch.

The cell has an asymmetric fan fold with one edge of the negative plates enfolded but with the other edge not enfolded and not covered at all over the 3015 exposed amount. Further, the cell has an asymmetric fan fold with one side of the fold indented the 3015 amount from the negative folds and the other side not enfolded but covered totally by two adjacent separator layers.

The cell has plates positioned and maintained in precise position with offsets between the positive and negative placement also maintained in precise or nearly precise position. The continuous separator with relatively rigid folds acts as an alignment fixture or jig and the formed stack of plates tend to stay in their relative positions even in the presence of vibration, tilting, or other mechanical disturbance.

FIG. 17 illustrate an exemplary embodiment of cells created by a machine and/or method as described above.

If justification or registration should be compromised by external forces, realignment is easily achieved by seating the negative exposed edges against a flat surface. This registers the negative plates with the plate and the positive plates with the positive edge folds.

While the present invention has been illustrated by the description of embodiments thereof, and while the embodiments have been described in considerable detail, the scope of the appended claims should not be restricted or in any way limited to such detail. Additional advantages and modifications will readily appear to those skilled in the art. Therefore, the invention, in its broader aspects, is not limited to the specific details, the representative systems, and illustrative examples shown and described. Accordingly, departures may be made from such details without departing from the spirit or scope of the invention disclosed herein.

In one embodiment the battery is a rechargeable, primary cell battery, with lithium ion battery plates. In such an embodiment, the negative plate is composed of a thin film of metal, usually copper, coated with carbon-polymer matrix. The positive plates are composed of a thin film of metal, usually aluminum, coated with a mix of carbon and lithium in which the lithium is present as lithium cobalt dioxide. The plates are conventional and are known as plates made by the “Sony Process”. Generally the plate thickness ranges from 1/1000 to 30/1000 of an inch thick, more typically 5/1000 to 20/1000 of an inch thick. Plates having a thickness greater than 30/1000 of an inch thick can assembled using the interleave machine however they are not as fragile and can often be assembled efficiently using conventional machines or by hand. Plates having a thickness of less than 1/1000 of an inch can also be assembled using the interleave machine, however in the battery industry few plates have a thickness of less than 1/1000 of an inch.

The separator useful in the lithium ion battery plate cells is a continuous sheet which is nonconductive, semi permeable membrane which allows the passage of the lithium ion. Good results have been obtained using membranes having thickness 8/10,000 inch. The separator sheet is conventional; such separator\sheets are commercially available Cellgaurd from Cellgaurd in Charlotte N.C.

Once the cell is assembled in the interleave machine at the copper tabs of the copper plates are attached to each other such as by welding, then they are affixed to a bus which is attached to the battery terminal. Similarly, the aluminum electrode tabs of the aluminum plates are attached by similar process and attached to the positive terminal.

The cell-terminal assembly is then placed in a canister, such as stainless steel and a non conductive barrier is placed inside the canister between the cell and the wall of the canister. Good results have been obtained using a plastic strip as a non-conductive barrier. The lid of the canister is then placed on the canister and sealed to the canister using conventional techniques. The electrolyte is then injected through a tiny hole in the canister, conventional electrolyte solutions are suitable. Where the battery plates are lithium ion battery plates a hydrocarbon electrolyte is typically used.

The above description of some of the embodiments of the present invention has been given by way of example. From the disclosure given, those skilled in the art will not only understand the present invention and its attendant advantages, but will also find apparent various changes and modifications to the structures and methods disclosed. It is sought, therefore, to cover all such changes and modifications as fall within the spirit and scope of the invention, as defined by the appended claims, and equivalents thereof.

What is claimed is:

1. An interleave stacking machine comprising:
a plate transfer device operable to pick up a flat plate from a first location and transfer said plate to a cassette;
a separator operable to be supplied in a continuous manner;
a separator guide operable to move said continuously supplied separator from one side of said cassette to an opposite side of said cassette; and
wherein said interleave stacking machine is operable to disposed said separator in a continuous interwoven manner between discrete plates.

2. The interleave stacking machine of claim 1, further comprising:
an anvil disposed at said cassette and operable to move in multiple directions relative to said cassette;
a clamp disposed above said anvil and operable to move in multiple directions relative to said cassette;
wherein said anvil and said clamp are operable to apply a force to said plate and separator which are disposed therebetween in order to create a fold in said separator

3. The interleave stacking machine of claim 1 wherein said flat plate has a thickness of less than or equal to 30/1000 of an inch.

4. A method for stacking plates with a separator disposed therebetween said plates in an interwoven manner, comprising the steps of:
picking up a first plate from a first location using a first plate transfer device;
disposing a continuous separator on a surface of a cassette;
transferring said first plate to said cassette;
placing said first plate on said separator; and
wrapping said continuous separator over a first edge of said first plate and across an upper surface of said first plate.

5. The method of claim 4 wherein said first plate has a thickness of less than or equal to 30/1000 of an inch.

6. The method of claim 4 wherein said first plate has a thickness in a range of 1/1000 to 30/1000 of an inch.

7. The method of claim 4 wherein said first plate has a thickness in a range of 5/1000 to 20/1000 of an inch.

8. The method of claim 4 further comprising the step of:
clamping said wrapped continuous separator and said edge of said first plate between a first anvil and a first clamp.

9. The method of claim 4 further comprising the steps of:
picking up a second plate from a second location using a second plate transfer device;
transferring said second plate to said cassette;
placing said second plate on top of said separator; and
wrapping said continuous separator over a edge of said second plate and across an upper surface of said second plate.

10. The method of claim 9 further comprising the step of:
clamping said wrapped continuous separator and said edge of said second plate between a second anvil and a second clamp

11. An interleave stacking machine comprising:
a first plate hopper disposed at a first location;
a second plate hopper disposed at a second location;
a first plate transfer device operable to pick up a first flat plate from said first plate hopper and transfer said first flat plate to a cassette;
a second plate transfer device operable to pick up second flat plate from said second plate hopper and transfer said second flat plate to said cassette;
a separator operable to be supplied in a continuous manner;
a separator guide operable to move said continuously supplied separator from one side of said cassette to an opposite side of said cassette;
a first anvil disposed at said cassette and operable to move in multiple directions relative to said cassette;
a second anvil disposed opposite said first anvil and operable to move in multiple directions relative to said cassette;
a first clamp disposed above said first anvil and operable to move in multiple directions relative to said cassette; and
a second clamp disposed above said second anvil and operable to move in multiple directions relative to said cassette;
wherein said interleave stacking machine is operable to disposed said separator in a continuous interwoven manner between discrete plates;
wherein said first anvil and said first clamp are operable to apply a force to said plate and separator which are disposed therebetween in order to create a fold in said separator;
wherein said second anvil and said second clamp are operable to apply a force to said plate and separator which are disposed therebetween in order to create a fold in said separator.

12. The interleave stacking machine of claim 11 wherein said first plate and said second plate each have a thickness of less than or equal to 30/1000 of an inch.

13. The interleave stacking machine of claim 111 wherein said first plate and said second plate each have a thickness in the range of 1/1000 to 30/1000 of an inch.

14. The interleave stacking machine of claim 11 wherein said first plate and said second plate each have a thickness in the range of 5/1000 to 20/1000 of an inch.

15. The interleave stacking machine of claim 11 wherein said first and second plate transfer devices are vacuums.

16. The interleave stacking machine of claim 11 wherein said first and second plate transfer devices are Bernoulli principal based devices.

17. The interleave stacking machine of claim 11 wherein cassette has a vertical actuator and an urging member.

18. The interleave stacking machine of claim 11 further comprising a separator feeder, a tension varying mechanism operable to receive said continuous separator from said separator feeder and an edge guide operable to control the orientation of said continuous separator.

19. The interleave stacking machine of claim 11 further comprising a movable carriage,
wherein said first plate transfer device, said second plate transfer device and separator guide are fixed to said carriage.

20. The interleave stacking machine of claim 11 further comprising a control unit operable to control the movement of said first plate transfer device, said second plate transfer device, said first clamp, said second clamp, said first anvil, said second anvil, said separator guide and said cassette.
